(19) United States
(12) Patent Application Publication
(10) Pub. No.: US 2007/0020490 A1
(43) Pub. Date: Jan. 25, 2007

(54) Magnetic recording medium

(75) Inventors: Takeshi Harasawa, Kanagawa (JP); Masahito Oyanagi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/489,534

(22) Filed: Jul. 20, 2006

(30) Foreign Application Priority Data
Jul. 20, 2005 (JP) 209713/2005

(51) Int. Cl. G11B 5/706

(52) U.S. Cl. 428/842.8; 428/844.1; 428/844

(57) ABSTRACT

Provided is a magnetic recording medium for high-density recording, that has excellent electromagnetic characteristics, error rates, and durability. The magnetic recording medium comprises a magnetic layer comprising a ferromagnetic powder, a binder and an abrasive on a nonmagnetic support and is employed for recording a magnetic signal on the medium and reproducing the recorded signal with a reproduction head. The abrasive has a Vickers hardness ranging from 18 to 80 GPa and a mean particle diameter ranging from 10 to 100 nm. The magnetic layer comprises the abrasive in a quantity of 5 to 60 weight parts per 100 weight parts of the ferromagnetic powder and has a thickness ranging from 10 to 100 nm. The number of abrasive present on the surface of the magnetic layer ranges from 0.01 to 1 per {(minimum bit length of the recorded signal)×(read track width of the reproduction head)} micrometer².

### CROSS-REFERENCE TO RELATED APPLICATIONS

This application claims benefit of priority under 35 USC 119 to Japanese Patent Application No. 2005-209713 filed on Jul. 20, 2005.

### BACKGROUND OF THE INVENTION

1. Field of the Invention

The present invention relates to a magnetic recording medium for high-density recording.

2. Discussion of the Background

As minicomputers, personal computers, and office computers such as workstations have become widespread, a great deal of research has been conducted into magnetic tapes for recording computer data that are employed as external memory media (so-called “backup tapes”). In the practical development of magnetic tapes for such applications, and, in particular, as computers have become smaller and their ability to process information has increased, a strong demand for greater storage capacity has developed to achieve high volume recording with size reduction. In response to such high-density recording, Japanese Unexamined Patent Publication (KOKAI) No. 2002-319118 proposes a reduction in the average size of the abrasive present on the surface of the magnetic layer to ⅓ or less the recording and reproduction track width. Further, Japanese Unexamined Patent Publication (KOKAI) 2005-4894 proposes controlling the number of protrusions on the surface of a magnetic layer containing diamond microparticles of prescribed particle diameter.

Reproduction heads based on a magnetoresistive (MR) operating principle have been proposed in recent years as being suited to high densification, and their use in hard disks and the like has begun. MR heads provide several times the reproduction output of conventional inductive magnetic heads. Since they do not employ induction coils, mechanical noise such as impedance noise is greatly reduced. By reducing the noise of the magnetic recording medium, it is possible to achieve a high S/N ratio and substantially improve high-density recording characteristics.

With the high density trend in recording in recent years, there has been increasing improvement in reproduction heads. The track width of recording heads has tended to narrow. However, when the recording track width is narrowed in response to high-density recording, output amplitude fluctuation (modulation) increases, creating a problem in the form of an increased error rate.

With the high densification of recording in recent years, the bit length of the signal being recorded and the read track width of the reproduction head have tended to become increasingly shorter. In such systems, the incorporation of ultrahard abrasives (for example, diamond) into the magnetic layer is conceivable as a method of improving electromagnetic characteristics and the error rate (see Japanese Unexamined Patent Publication (KOKAI) 2005-4894). However, an ultrahard abrasive runs the risk of causing head abrasion and deterioration in durability.

### SUMMARY OF THE INVENTION

In light of these problems, it is an object of the present invention to provide a magnetic recording medium for high-density recording, that has excellent electromagnetic characteristics, error rates, and durability.

The present inventors conducted extensive research into achieving excellent electromagnetic characteristics, error rates, and durability in a high-density recording region, resulting in the discovery that the aforementioned object can be achieved by controlling the dispersion state of abrasive having prescribed hardness and particle diameter based on systems. The present invention was devised on that basis.

The present invention relates to a magnetic recording medium comprising a magnetic layer comprising a ferromagnetic powder, a binder and an abrasive on a nonmagnetic support, wherein

said magnetic recording medium is employed for recording a magnetic signal on the medium and reproducing the recorded signal with a reproduction head,

said abrasive has a Vickers hardness ranging from 18 to 80 GPa and a mean particle diameter ranging from 10 to 100 nm,

said magnetic layer comprises said abrasive in a quantity of 5 to 60 weight parts per 100 weight parts of the ferromagnetic powder,

said magnetic layer has a thickness ranging from 10 to 100 nm, and

the number of abrasive present on the surface of said magnetic layer ranges from 0.01 to 1 per {(minimum bit length of the recorded signal)×(read track width of the reproduction head)} micrometer².

The present invention further relates to a method of recording a magnetic signal on a magnetic recording medium and reproducing the recorded signal with a reproduction head, wherein

said magnetic recording medium comprises a magnetic layer comprising a ferromagnetic powder, a binder and an abrasive on a nonmagnetic support,

said abrasive has a Vickers hardness ranging from 18 to 80 GPa and a mean particle diameter ranging from 10 to 100 nm,

said magnetic layer comprises said abrasive in a quantity of 5 to 60 weight parts per 100 weight parts of the ferromagnetic powder,

said magnetic layer has a thickness ranging from 10 to 100 nm, and

the number of abrasive present on the surface of said magnetic layer ranges from 0.01 to 1 per {(minimum bit length of the recorded signal)×(read track width of the reproduction head)} micrometer².

The present invention still further relates to an apparatus comprising a recording head, a magnetic recording medium and a reproduction head, wherein

said recording head records a magnetic signal on said magnetic recording medium and said reproduction head reproduces the recorded signal,

said magnetic recording medium comprises a magnetic layer comprising a ferromagnetic powder, a binder and an abrasive on a nonmagnetic support,

said abrasive has a Vickers hardness ranging from 18 to 80 GPa and a mean particle diameter ranging from 10 to 100 nm,

said magnetic layer comprises said abrasive in a quantity of 5 to 60 weight parts per 100 weight parts of the ferromagnetic powder,

said magnetic layer has a thickness ranging from 10 to 100 nm, and

the number of abrasive present on the surface of said magnetic layer ranges from 0.01 to 1 per {(minimum bit length of the recorded signal)×(read track width of the reproduction head)} micrometer².

In the above magnetic recording medium, said abrasive preferably has a mean particle diameter of not greater than twice the minimum bit length of said recorded signal.

In the above magnetic recording medium, said magnetic layer preferably has a surface roughness Ra of equal to or less than 2.0 nm.

In the above magnetic recording medium, said ferromagnetic powder is preferably a hexagonal ferrite powder having a mean plate diameter ranging from 10 to 40 nm or a ferromagnetic metal powder having a mean major axis length ranging from 25 to 100 nm.

In the above magnetic recording medium, the minimum bit length of said recorded signal is equal to or less than 100 nm.

In the above magnetic recording medium, the read track width of said reproduction head is equal to or less than 2500 nm.

The above magnetic recording medium can further comprises an intermediate layer comprising a principal component in the form of a radiation-curing resin between the nonmagnetic support and the magnetic layer.

The above magnetic recording medium can further comprises a nonmagnetic layer comprising a nonmagnetic powder and a binder between the nonmagnetic support and the magnetic layer. In this case, the magnetic recording medium can further comprises an intermediate layer comprising a principal component in the form of a radiation-curing resin between the nonmagnetic support and the nonmagnetic layer or the nonmagnetic layer and the magnetic layer.

According to the present invention, a magnetic recording medium with improved electromagnetic characteristics, error rate and durability, particularly in the high-density region can be provided.

### DESCRIPTIONS OF THE EMBODIMENTS

The present invention will be described in greater detail below.

The magnetic recording medium of the present invention comprises a magnetic layer comprising a ferromagnetic powder, a binder and an abrasive on a nonmagnetic support and it is employed for recording a magnetic signal on the medium and reproducing the recorded signal with a reproduction head. Said abrasive has a Vickers hardness ranging from 18 to 80 GPa and a mean particle diameter ranging from 10 to 100 nm, said magnetic layer comprises said abrasive in a quantity of 5 to 60 weight parts per 100 weight parts of the ferromagnetic powder, said magnetic layer has a thickness ranging from 10 to 100 nm, and the number of abrasive present on the surface of said magnetic layer ranges from 0.01 to 1 per {(minimum bit length of the recorded signal)×(read track width of the reproduction head)} micrometer².

The abrasive incorporated into the magnetic layer has a Vickers hardness ranging from 18 to 80 GPa. With an abrasive having a Vickers hardness of less than 18 GPa, head grime cannot be removed and it is difficult to ensure running durability. Further, with an abrasive having a Vickers hardness exceeding 80 GPa, head abrasion becomes marked. The Vickers hardness of the abrasive is preferably from 18 to 50 GPa, more preferably from 20 to 30 GPa. Examples of abrasives having a Vickers hardness of 18 to 80 GPa are SiC, TiC and CBN. Of these, carbides such as SiC and TiC has a hardness close to that of the head material, and thus afford good abrasion nd grime removal properties. The Vickers hardness of the abrasive can be measured by pressing a pyramidal indenter with a vertical angle of 136° into a sample with a prescribed load and evaluating the hardness from the indentations formed.

The mean particle diameter of the abrasive falls within a range of 10 to 100 nm. With an abrasive having a particle diameter of less than 10 nm, few abrasive particles protrude from the surface of the magnetic layer, making it difficult to remove head grime. With an abrasive having a particle diameter exceeding 100 nm, an excessively large number of abrasive particles protrude from the surface of the magnetic layer, presenting the risk of head abrasion. The mean particle diameter of the abrasive is preferably 30 to 90 nm, more preferably 50 to 80 nm. The mean particle diameter of the abrasive can be calculated as the average value obtained with a particle size distribution measuring device by laser scattering.

The mean particle diameter of the abrasive incorporated into the magnetic layer is preferably not greater than twice the minimum bit length of the recorded signal. This is because signals that are often employed as data frequently have bit lengths that are two or more times the minimum bit length. The mean particle diameter of the abrasive incorporated into the magnetic layer more preferably falls within a range of 1 to 2 times the minimum bit length of the recorded signal.

The abrasive having the above-stated prescribed Vickers hardness and mean particle diameter is incorporated into the magnetic layer in a quantity of 5 to 60 weight parts per 100 weight parts of the ferromagnetic powder. When the quantity of abrasive incorporated is less than 5 weight parts, head grime cannot be removed and running durability deteriorates. Conversely, when the quantity of abrasive incorporated exceeds 60 weight parts, head abrasion becomes pronounced.

The number of abrasive present on the surface of the magnetic layer is controlled to from 0.01 to 1 per {(minimum bit length of the recorded signal)×(read track width of the reproduction head)} micrometer². Controlling the number of abrasive present on the surface of the magnetic layer based on a recording and reproduction system in this manner makes it possible to obtain excellent electromagnetic characteristics and error rate in a magnetic recording medium having a magnetic layer 10 to 100 nm, preferably 30 to 80 nm, in thickness. Further, incorporating a prescribed quantity of abrasive of prescribed Vickers hardness and mean particle diameter into the magnetic layer as set forth above both prevents head abrasion and ensures running durability. According to the present invention as set forth above, a magnetic recording medium having excellent electromagnetic characteristics, error rate, and durability can be obtained.

In the magnetic recording medium of the present invention as set forth above, the number of abrasive present on the surface of the magnetic layer ranges from 0.01 to 1 per {(minimum bit length of the recorded signal)×(read track width of the reproduction head)} micrometer². When the number of abrasive present on the surface of the magnetic layer is fewer than 0.01 per {(minimum bit length of the recorded signal)×(read track width of the reproduction head)} micrometer², the coating reinforcement effect rapidly decreases and durability becomes difficult to ensure. When the number of abrasive present on the surface of the magnetic layer exceeds 1 per {(minimum bit length of the recorded signal)×(read track width of the reproduction head)} micrometer², head abrasion increases and the head life decreases. The number of abrasive present on the surface of the magnetic layer is preferably 0.1 to 0.5 per {(minimum bit length of the recorded signal)×(read track width of the reproduction head)} micrometer². The number of abrasive on the surface of the magnetic layer can be calculated by observing the surface with a low-voltage scanning electron microscope at equal to or less than 5 kV and measuring the number of abrasive present.

The number of abrasive present on the surface of the magnetic layer can be controlled by adjusting the particle diameter of the abrasive and the quantity of abrasive added. For example, for the addition of a given quantity of abrasive, the use of abrasive of smaller particle diameter increases the number of abrasive particles on the surface of the magnetic layer. Control can also be effected by regulating the degree of dispersion. For example, in order to disperse abrasive so as to achieve the degree of dispersion much smaller than what is conventionally achieved, the abrasive can be mixed with a dispersing medium such as ZrO₂ having high specific gravity and a mean particle diameter of about 10 micrometers and then dispersed. The dispersing device employed can be a common bead dispersing device. Dispersion is conducted to achieve a desired particle diameter. Finally, after filtering with a filter having a mean pore diameter of about 5 micrometers, filtering is conducted with a filter having a mean pore diameter of 1 micrometer or less.

In the magnetic recording medium of the present invention, the surface roughness Ra of the magnetic layer is preferably equal to or less than 2.0 nm. When the surface roughness Ra of the magnetic layer is equal to or less than 2.0 nm, the reduction in spacing loss that has been sought in the high recording densification of recent years can be achieved. The surface roughness Ra of the magnetic layer more preferably falls within a range of 1.2 to 1.8 nm. In the present invention, the surface roughness Ra refers to the center surface average surface roughness as measured by atomic force microscopy (AFM).

To control the surface roughness Ra of the magnetic layer, in addition to the method of controlling the dispersion state of the abrasive as set forth above, it is also possible to provide an intermediate layer comprising a principal component in the form of a radiation-curing resin. The phrase “comprising a principal component in the form of a radiation-curing resin” means that the quantity of radiation-curing resin in the intermediate layer is equal to or greater than 50 weight percent, for example. The radiation-curing resin has the property of curing by polymerizing or crosslinking to form a polymer when exposed to energy in the form of radiation such as an electron beam or ultraviolet radiation. In radiation-curing resins, the reaction does not progress unless energy is imparted. For this reason, a coating liquid containing a radiation-curing resin will be of relatively low viscosity, having a stable viscosity so long as it is not exposed to radiation. Thus, after applying an intermediate layer coating liquid onto a nonmagnetic layer or onto a nonmagnetic support, before the coating liquid dries, the roughness and protrusions in the surface of the nonmagnetic layer or the surface of the nonmagnetic support can be masked by a leveling effect, yielding a smooth intermediate layer. A highly dispersed magnetic layer coating liquid can be applied on the smooth intermediate layer to obtain a magnetic layer having a highly smooth surface. Thus, it is possible to obtain a magnetic recording medium having good electromagnetic characteristics and a reduced error rate. Further, the radiation-curing resin instantly reacts when exposed to high-energy radiation, making it possible to obtain an intermediate layer of high coating strength, and thus increase the strength of the magnetic recording medium. The above effects are particularly marked when the magnetic layer is thin, such as in magnetic recording media having a magnetic layer 10 to 100 nm in thickness. Providing an intermediate layer also has the effect of reducing microprotrusions on the surface of the magnetic layer which tend to cause noise in magnetic recording media employing MR heads that have come into use with the high recording densities of recent years.

The magnetic recording medium of the present invention can have a layer structure of the nonmagnetic support/the intermediate layer/the magnetic layer.

As will be set forth further below, in the magnetic recording medium of the present invention, a nonmagnetic layer can be provided between the nonmagnetic support and the magnetic layer. In this case, the intermediate layer can be formed either on the nonmagnetic support or the nonmagnetic layer. That is, the magnetic layer of the present invention can have a layer structure of the nonmagnetic support/the intermediate layer/the nonmagnetic layer/the magnetic layer or the nonmagnetic support/the nonmagnetic layer/the intermediate layer/the magnetic layer.

From the perspective of obtaining a substantial masking effect, the viscosity of the radiation-curing resin employed in the intermediate layer is preferably equal to or less than 40,000 mPa·s, more preferably equal to or less than 10,000 mPa·s, and further preferably, falls within a range of 50 to 5,000 mPa·s. The viscosity of the radiation-curing resin referred to in the present invention denotes the viscosity of the resin component (without solvent) prior to radiation curing, as measured at 20° C. The number average molecular weight of the radiation-curing resin is preferably 200 to 1,000, more preferably 200 to 500.

Examples of radiation-curing resins are: acrylic acid esters, acrylamides, methacrylic acid esters, methacrylic acid amides, allyl compounds, vinyl ethers, and vinyl esters. Of these, the acrylic acid esters and methacrylic acid esters are preferred, with acrylic acid esters having two or more radiation-curing functional groups being particularly preferred. The radiation-curing functional groups may be acryloyl groups or methacryloyl groups, for example. Of these, radiation-curing functional groups in the form of acryloyl groups are preferred.

The radiation-curing resin preferably has an alicyclic ring structure. Alicyclic ring structures include structures having a cyclo skeleton, a bicyclo skeleton, a tricyclo skeleton, a spiro skeleton, a dispiro skeleton and the like. Of these, alicyclic ring structures in the form of structures comprised of multiple rings with shared atoms, such as structures having a bicyclo skeleton, a tricyclo skeleton, a spiro skeleton, a dispiro skeleton and the like are preferred. Examples of such skeletons are esters and amides yielding residues of polyols and polyamines forming radiation-curing resins. The radiation-curing resin may be formed by bonding radiation-curing functional groups to such residues.

Since the radiation-curing resin having an alicyclic ring structure has a higher glass transition temperature than that having an aliphatic ring structure, adhesion failure in the steps following coating of the intermediate layer can be reduced. The presence of cyclohexane rings or alicyclic skeletons such as bicyclo, tricyclo and spiro and the like reduces coating shrinkage due to curing and improves adhesive strength to the nonmagnetic layer (or nonmagnetic support when a nonmagnetic layer is not provided).

Specific examples of radiation-curing resins are given below: cyclopropane diacrylate, cyclopentane diacrylate, cyclohexane diacrylate, cyclobutane diacrylate, dimethylol cyclopropane diacrylate, dimethylol cyclopentane diacrylate, dimethylol cyclohexane diacrylate, dimethylol cyclobutane diacrylate, cyclopropane dimethyacrylate, cyclopentane dimethacrylate, cyclohexane dimethacrylate, cyclobutane dimethacrylate, dimethylol cyclopropane dimethacrylate, dimethylol cyclopentane dimethacrylate, dimethylol cyclohexane dimethacrylate, dimethylol cyclobutane dimethacrylate, bicyclobutane diacrylate, bicyclooctane diacrylate, bicyclononane diacrylate, bicycloundecane diacrylate, dimethylol bicyclobutane diacrylate, dimethylol bicyclooctane diacrylate, dimethylol bicyclononane diacrylate, dimethylol bicyclo undecane diacrylate, bicyclobutane dimethacrylate, bicyclooctane dimethacrylate, bicyclononane dimethacrylate, bicycloundecane dimethacrylate, dimethylol bicyclobutane dimethacrylate, dimethylol bicyclooctane dimethacrylate, dimethylol bicyclononane dimethacrylate, dimethylol bicycloundecane dimethacrylate, tricycloheptane diacrylate, tricyclodecane diacrylate, tricyclododecane diacrylate, tricycloundecane diacrylate, tricyclotetradecane diacrylate, tricyclodecane tridecane diacrylate, dimethylol tricycloheptane diacrylate, dimethylol tricyclodecane diacrylate, dimethylol tricyclododecane diacrylate, dimethylol tricycloundecane diacrylate, dimethylol tricyclotetradecane diacrylate, dimethylol tricyclodecane tridecane diacrylate, tricycloheptane dimethacrylate, tricyclodecane dimethacrylate, tricyclododecane dimethacrylate, tricycloundecane dimethacrylate, tricyclotetradecane dimethacrylate, tricyclodecane tridecane dimethacrylate, dimethylol tricycloheptane dimethacrylate, dimethylol tricyclodecane dimethacrylate, dimethylol tricyclododecane dimethacrylate, dimethylol tricycloundecane dimethacrylate, dimethylol tricyclotetradecane dimethacrylate, dimethylol tricyclodecane tridecane dimethacrylate, spirooctane diacrylate, spiroheptane diacrylate, spirodecane diacrylate, cyclopentane spirocyclobutane diacrylate, cyclohexane spirocyclopentane diacrylate, spirobicyclohexane diacrylate, dispiroheptadecane diacrylate, dimethylol spirooctane diacrylate, dimethylol spiroheptane diacrylate, dimethylol spirodecane diacrylate, dimethylol cyclopentane spirocyclobutane diacrylate, dimethylol cyclohexane spirocyclopentane diacrylate, dimethylol spirobicyclohexane diacrylate, dimethylol dispiroheptadecane diacrylate, spirooctane dimethacrylate, spiroheptane dimethacrylate, spirodecane dimethacrylate, cyclopentane spirocyclobutane dimethacrylate, cyclohexane spirocyclopentane dimethacrylate, spirobicyclohexane dimethacrylate, dispiroheptadecane dimethacrylate, dimethylol spirooctane dimethacrylate, dimethylol spiroheptane dimethacrylate, dimethylol spirodecane dimethacrylate, dimethylol cyclopentane spirocyclobutane dimethacrylate, dimethylol cyclohexane spirocyclopentane dimethacrylate, dimethylol spirobicyclohexane dimethacrylate, and dimethylol dispiroheptadecane dimethacrylate. Of these, the preferred resins are dimethylol tricyclodecane diacrylate, dimethylol bicyclooctane diacrylate, and dimethylol spirooctane diacrylate. The resin of particular preference is dimethylol tricyclodecane diacrylate. Specific examples of commercially available compounds are KAYARAD R-684, made by Nippon Kayaku Co., Ltd., Rite Acrylate DCP-A, made by Kyoeisha Chemical Co., Ltd., and LUMICURE DCA-200, made by Dainippon Ink and Chemicals, Incorporated.

The radiation-curing resin described in Japanese Unexamined Patent Publication (KOKAI) 2002-117520 can also be employed in the present invention, for example. The nonmagnetic powder, carbon black, and the like that are employed in the nonmagnetic layer, described further below, may be incorporated into the intermediate layer. However, to obtain good surface properties, these are desirably not incorporated. When used, they are desirably incorporated in a proportion of 30 percent or less based on volume so that the surface properties do not deteriorate.

An intermediate layer coating liquid can be prepared by dissolving the radiation-curing resin in a suitable solvent. Solvents of preference are: methyl ethyl ketone (MEK), methanol, ethanol, and toluene. The quantity of solvent employed can be 2 to 50 times the weight of radiation-curing resin.

The intermediate layer coating liquid is coated and dried on the nonmagnetic layer or on the nonmagnetic support and then cured by exposure to radiation. The glass transition temperature Tg following curing is preferably 80 to 150° C., more preferably 100 to 130° C. When the Tg is equal to or greater than 80° C., adhesion failure does not occur during the coating step, and when the Tg is equal to or less than 150° C., a high-strength coating can be obtained.

Examples of the radiation used in the present invention are an electron beam and ultraviolet radiation. When employing ultraviolet radiation, it becomes necessary to add a photopolymerization initiator to the intermediate layer coating liquid. When curing with an electron beam, no polymerization initiator is required and deep transmittance is afforded. Therefore, the use of radiation in the form of an electron beam is preferred. A scanning-type, double scanning-type, or curtain beam-type electron beam accelerator may be employed. The curtain beam-type device is preferred because of its relatively low cost and high output. The electron beam characteristics are as follows: the acceleration voltage is normally 30 to 1,000 kV, preferably 50 to 300 kV; and the absorbed dose is normally 0.5 to 20 Mrad, preferably 2 to 10 Mrad. Ample energy transmittance can be achieved at acceleration voltages of equal to or greater than 30 kV, and acceleration voltages of equal to or less than 1,000 kV is economical because of high efficiency of energy employed in polymerization. The atmosphere in which the electron beam is irradiated is desirably purged with nitrogen to an oxygen concentration of equal to or less than 200 ppm. When the oxygen concentration is high, crosslinking and curing reactions are blocked near the surface.

A mercury lamp can be employed as a source of ultraviolet radiation. For example, a 20 to 240 W/cm mercury lamp may be employed at a speed of 0.3 m/min to 20 m/min. A distance between the base and the mercury lamp of 1 to 30 cm is generally desirable. Photoradical polymerization initiators can be employed as the photopolymerization initiator in ultraviolet curing. Details of photopolymerization initiators are described in “New polymer Experimentology, Vol. 2, Chapter 6, Photo and Radiation Polymerization” (Kyoritsu Shuppan, pub. 1995, comp. by the Polymer Society), for example. Specific examples are: acetophenone, benzophenone, anthraquinone, benzoin ethyl ether, benzyl methyl ketal, benzyl ethyl ketal, benzoin isobutyl ketone, hydroxydimethyl phenyl ketone, 1-hydroxycyclohexyl phenyl ketone, and 2-2-diethoxyacetophenone. The photopolymerization initiator is normally admixed in a proportion of 0.5 to 20 weight parts, preferably 2 to 15 weight parts, and more preferably 3 to 10 weight parts, per 100 weight parts of radiation-curing resin. Known radiation curing devices and conditions may be employed; these are described in “UV·EB curing techniques” (pub. by the Comprehensive Technology Center (Ltd.)); “Low-energy electron-beam irradiation application techniques” (2000, pub. by CMC (Ltd.)); and the like.

The thickness of the intermediate layer is preferably from 0.05 to 2 micrometers, more preferably 0.5 to 1 micrometer. When the thickness of the intermediate layer is equal to or greater than 0.05 micrometer, protrusions on the nonmagnetic layer or protrusions on the nonmagnetic support can be effectively masked. When the intermediate layer is excessively thick, shrinkage of the intermediate layer causes considerable cupping and runs the risk of compromising head contact; such problems do not occur when the thickness of the intermediate layer is equal to or less than 2 micrometers.

To obtain a magnetic layer of high surface smoothness in the present invention, the surface of the intermediate layer is desirably smooth. Thickness variation can be employed as an index of the surface smoothness of the intermediate layer. “Thickness variation” is a value calculated as “standard deviation sigma/layer thickness”. The thickness variation can be calculated by observing an ultrathin section of the magnetic tape (for example, 10 micrometers in length) at 50,000-fold magnification, for example, by transmission electron microscopy (TEM).

In the present invention, the thickness variation of the intermediate layer is preferably equal to or less than 50 percent, more preferably 0 to 25 percent. When the thickness variation of the intermediate layer is equal to or less than 50 percent, it is possible to provide a magnetic layer of high surface smoothness over the intermediate layer. In the present invention, as will be set forth further below, an intermediate layer coating liquid can be coated and dried on the nonmagnetic support or the nonmagnetic layer formed by coating and drying a nonmagnetic layer coating liquid, and the surface roughness and protrusions on the nonmagnetic support or the nonmagnetic layer can be masked by a leveling effect to form an intermediate layer with a smooth surface and a thickness variation of equal to or less than 50 percent.

[Magnetic Layer]

In the present invention, examples of the ferromagnetic powder contained in the magnetic layer are a ferromagnetic metal powder and a hexagonal ferrite powder.

The ferromagnetic metal powder is preferably a ferromagnetic metal power comprised primarily of alpha —Fe. In addition to prescribed atoms, the following atoms can be contained in the ferromagnetic metal powder: Al, Si, Ca, Mg, Ti, Cr, Cu, Y, Sn, Sb, Ba, W, La, Ce, Pr, Nd, P, Co, Mn, Zn, Ni, Sr, B and the like. Particularly, incorporation of at least one of the following in addition to alpha —Fe is desirable: Al, Ca, Mg, Y, Ba, La, Nd, Sm, Co and Ni. Incorporation of Co is particularly preferred because saturation magnetization increases and demagnetization is improved when Co forms an alloy with Fe. The Co content preferably ranges from 1 to 40 atom percent, more preferably from 15 to 35 atom percent, further preferably from 20 to 35 atom percent with respect to Fe. The content of rare earth elements such as Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe. Al and rare earth elements including Y function as sintering preventing agents, making it possible to achieve a greater sintering prevention effect when employed in combination. These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reducing hydroscopic iron oxide subjected to sintering preventing treatment or iron oxide with a reducing gas such as hydrogen to obtain Fe or Fe—Co particles or the like; methods of reduction with compound organic acid salts (chiefly oxalates) and reducing gases such as hydrogen; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. The ferromagnetic metal powders obtained in this manner may be subjected to any of the known slow oxidation treatments. The method of reducing hydroscopic iron oxide or iron oxide with a reducing gas such as hydrogen and forming an oxide coating on the surface thereof by adjusting a partial pressure of oxygen-containing gas and inert gas, temperature and time is preferred because of low demagnetization.

The ferromagnetic metal powder preferably has a specific surface area (S_{BET}) by BET method of 40 to 80 m²/g, more preferably 45 to 70 m²/g. When the specific surface area by BET method is 40 m²/g or more, noise drops, and at 80 m²/g or less, surface smoothness are good. The crystallite size of the ferromagnetic metal powder is preferably 80 to 180 angstroms, more preferably 100 to 170 angstroms, and further preferably, 110 to 165 angstroms. The mean major axis length of the ferromagnetic metal powder preferably ranges from 25 to 100 nm, more preferably 25 to 50 nm, further preferably 25 to 40 nm. When the mean major axis length is 25 nm or more, magnetization loss due to thermal fluctuation does not occur, and at 100 nm or less, deterioration of error rate due to increased noises can be avoided. The mean acicular ratio {mean of (major axis length/minor axis length)} of the ferromagnetic metal powder preferably ranges from 3 to 15, more preferably from 3 to 10. The saturation magnetization (sigmaₛ) of the ferromagnetic metal powder preferably ranges from 90 to 170 A·m²/kg, more preferably from 100 to 160 A·m²/kg, and further preferably from 110 to 160 A·m²/kg. The coercivity of the ferromagnetic metal powder preferably ranges from 1,700 to 3,500 Oe, approximately 135 to 279 kA/m, more preferably from 1,800 to 3,000 Oe, approximately 142 to 239 kA/m.

The moisture content of the ferromagnetic metal powder preferably ranges from 0.1 to 2 weight percent; the moisture content of the ferromagnetic metal powder is desirably optimized depending on the type of binder. The pH of the ferromagnetic metal powder is desirably optimized depending on the combination with the binder employed; the range is normally pH 6 to 12, preferably pH 7 to 11. The stearic acid (SA) adsorption capacity (that is a measure of surface basicity) of the ferromagnetic powder preferably ranges from 1 to 15 micromol/m², more preferably from 2 to 10 micromol/m², further preferably from 3 to 8 micromol/m². When employing a ferromagnetic metal powder of which stearic acid adsorption capacity is high, the surface of the ferromagnetic metal powder is desirably modified with organic matter strongly adsorbed to the surface to manufacture a magnetic recording medium. An inorganic ion in the form of soluble Na, Ca, Fe, Ni, Sr, NH₄, SO₄, Cl, NO₂, NO₃ or the like may be contained in the ferromagnetic metal powder. These are preferably substantially not contained, but at levels of equal to or less than 300 ppm, characteristics are seldom affected. Further, the ferromagnetic metal powder employed in the present invention desirably has few pores. The content of pores is preferably equal to or less than 20 volume percent, more preferably equal to or less than 5 volume percent. So long as the above-stated particle size and magnetic characteristics are satisfied, the particles may be acicular, rice-particle shaped, or spindle-shaped. The shape is particularly preferably acicular. The magnetic recording medium with low SFD (switching-field distribution) is suited to high-density digital magnetic recording because magnetization switching is sharp and peak shifts are small. It is preferable to narrow the Hc distribution of the ferromagnetic metal powder. A low Hc distribution can be achieved, for example, by improving the goethite particle size distribution, by employing monodisperse alpha-Fe₂O₃, and by preventing sintering between particles and the like in the ferromagnetic metal powder.

Examples of hexagonal ferrite powders suitable for use in the present invention are barium ferrite, strontium ferrite, lead ferrite, calcium ferrite, and various substitution products thereof, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Nb, Sn, Ti, V, Cr, Cu, Y, Mo, Rh, Pd, Ag, Sn, Sb, Te, W, Re, Au, Bi, La, Ce, Pr, Nd, P, Co, Mn, Zn, Ni, B, Ge, Nb and the like. Compounds to which elements such as Co—Zn, Co—Ti, Co—Ti—Zr, Co—Ti—Zn, Ni—Ti—Zn, Nb—Zn—Co, Sn—Zn—Co, Sn—Co—Ti and Nb—Zn have been added may generally also be employed. They may comprise specific impurities depending on the starting materials and manufacturing methods employed. The mean plate diameter preferably ranges from 10 to 40 nm, more preferably 15 to 35 nm, further preferably 20 to 30 nm. Particularly when employing an MR head in reproduction to increase a track density, a plate diameter equal to or less than 40 nm is desirable to reduce noise. A mean plate diameter equal to or higher than 10 nm yields stable magnetization without the effects of thermal fluctuation. A mean plate diameter equal to or less than 40 nm permits low noise and is suited to the high-density magnetic recording. The mean plate thickness preferably ranges from 4 to 15 nm. Consistent production is possible when the mean plate thickness is equal to or higher than 4 nm and adequate orientation can be obtained when the mean plate thickness is equal to or less than 15 nm.

The plate ratio (plate diameter/plate thickness) of the hexagonal ferrite powder preferably ranges from 1 to 15, more preferably from 1 to 7. Low plate ratio is preferable to achieve high filling property of the magnetic layer, but some times adequate orientation is not achieved. When the plate ratio is higher than 15, noise may be increased due to stacking between particles. The specific surface area by BET method of the hexagonal ferrite powders having such particle sizes ranges from 30 to 200 m²/g, almost corresponding to an arithmetic value from the particle plate diameter and the plate thickness. Narrow distributions of particle plate diameter and thickness are normally good. Although difficult to render in number form, about 500 particles can be randomly measured in a transmission electron microscope (TEM) photograph of particles to make a comparison. This distribution is often not a normal distribution. However, when expressed as the standard deviation to the average particle size, sigma/average particle size=0.1 to 1.5. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known. According to a vitrified crystallization method, powders with increased uniformity can be obtained by conducting several thermal treatments to separate crystal nucleation and growth.

A coercivity (Hc) of the hexagonal ferrite powder of about 500 to 5,000 Oe, approximately 40 to 398 kA/m, can normally be achieved. A high coercivity (Hc) is advantageous for high-density recording, but this is limited by the capacity of the recording head. The coercivity (Hc) can be controlled by particle size (plate diameter and plate thickness), the types and quantities of elements contained, substitution sites of the element, the particle producing reaction conditions, and the like. The saturation magnetization (sigmaₛ) can be 30 to 70 A·m²/kg and it tends to decrease with decreasing particle size. Known methods of improving saturation magnetization (sigmaₛ) are lowering crystallization temperature or thermal treatment temperature, shortening thermal treatment time, increasing the amount of compound added, enhancing the level of surface treatment and the like. It is also possible to employ W-type hexagonal ferrite. When dispersing the hexagonal ferrite, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added can range from 0.1 to 10 weight percent relative to the weight of the hexagonal ferrite powder. The pH of the hexagonal ferrite powder is also important to dispersion. A pH of about 4 to 12 is usually optimum for the dispersion medium and polymer. From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.1 to 2.0 weight percent.

Methods of manufacturing the hexagonal ferrite include: (1) a vitrified crystallization method consisting of mixing into a desired ferrite composition barium carbonate, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to 100° C. or greater; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention.

Examples of types of carbon black that are suitable for use in the magnetic layer are: furnace black for rubber, thermal for rubber, black for coloring, conductive carbon and acetylene black. A specific surface area of 5 to 500 m²/g, a DBP oil absorption capacity of 10 to 400 m/100 g, and a mean particle size of 5 to 300 nm, a pH of 2 to 10 and a moisture content of 0.1 to 10 weight percent and a tap density of 0.1 to 1 g/cc are respectively desirable. Specific examples of types of carbon black employed in the magnetic layer are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Lion Akzo Co., Ltd. The carbon black employed may be surface-treated with a dispersant or grafted with resin, or have a partially graphite-treated surface. The carbon black may be dispersed in advance into the binder prior to addition to the magnetic layer coating liquid. These carbon blacks may be used singly or in combination. The quantity of carbon black comprised in the magnetic layer preferably ranges from 0.1 to 30 weight percent relative to the ferromagnetic powder. In the magnetic layer, carbon black works to prevent static, reduce the coefficient of friction, impart light-blocking properties, enhance film strength, and the like; the properties vary with the type of carbon black employed. Accordingly, in order to achieve desired characteristics, it is preferred that the type and the quantity of carbon black employed in the present invention are selected based on the various characteristics stated above, such as particle size, oil absorption capacity, electrical conductivity, and pH. For example, Carbon Black Handbook compiled by the Carbon Black Association may be consulted for types of carbon black suitable for use in the present invention.

Conventionally known thermoplastic resins, thermosetting resins, reactive resins and mixtures thereof may be employed as binders used in the magnetic layer. The thermoplastic resins suitable for use have a glass transition temperature of −100 to 150° C., a number average molecular weight of 1,000 to 200,000, preferably from 10,000 to 100,000, and have a degree of polymerization of about 50 to 1,000. Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten. It is also possible to employ known electron beam-cured resins. Examples and manufacturing methods of such resins are described in Japanese Unexamined Patent Publication (KOKAI) Showa No. 62-256219. The above-listed resins may be used singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate.

Known structures of polyurethane resin can be employed, such as polyester polyurethane, polyether polyurethane, polyether polyester polyurethane, polycarbonate polyurethane, polyester polycarbonate polyurethane, and polycaprolactone polyurethane. To obtain better dispersibility and durability in all of the binders set forth above, it is desirable to introduce by copolymerization or addition reaction one or more polar groups selected from among —COOM, —SO₃M, —OSO₃M, —P═O(OM)₂, —O—P═O(OM)₂ (where M denotes a hydrogen atom or an alkali metal base), —OH, —NR₂, —N⁺R₃ (where R denotes a hydrocarbon group), epoxy groups, —SH, and —CN. The quantity of the polar group is preferably from 10⁻¹ to 10⁻⁸ mol/g, more preferably from 10⁻² to 10⁻⁶ mol/g.

Specific examples of the binders employed in the present invention are VAGH, VYHH, VMCH, VAGF, VAGD, VROH, VYES, VYNC, VMCC, XYHL, XYSG, PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The binder employed in the magnetic layer is normally employed in a range of 5 to 50 weight percent, preferably from 10 to 30 weight percent with respect to the ferromagnetic powder. Vinyl chloride resin, polyurethane resin, and polyisocyanate are preferably combined within the ranges of: 5 to 30 weight percent for vinyl chloride resin, when employed; 2 to 20 weight percent for polyurethane resin, when employed; and 2 to 20 weight percent for polyisocyanate. However, when a small amount of dechlorination causes head corrosion, it is also possible to employ polyurethane alone, or employ polyurethane and isocyanate alone. In the present invention, when polyurethane is employed, a glass transition temperature of −50 to 150° C., preferably 0 to 100° C., an elongation at break of 100 to 2,000 percent, a stress at break of 0.05 to 10 kg/mm², approximately 0.49 to 98 MPa, and a yield point of 0.05 to 10 kg/mm², approximately 0.49 to 98 MPa, are desirable.

Examples of polyisocyanates suitable for use in the present invention are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used singly or in combinations of two or more by exploiting differences in curing reactivity.

Substances having lubricating effects, antistatic effects, dispersive effects, plasticizing effects, or the like may be employed as additives in the magnetic layer. Examples of additives are: molybdenum disulfide; tungsten disulfide; graphite; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; phenylphosphonic acid; alpha-naphthylphosphoric acid; phenylphosphoric acid; diphenylphosphoric acid; p-ethylbenzenephosphonic acid; phenylphosphinic acid; aminoquinones; various silane coupling agents and titanium coupling agents; fluorine-containing alkylsulfuric acid esters and their alkali metal salts; monobasic fatty acids (which may contain an unsaturated bond or be branched) having 10 to 24 carbon atoms and metal salts (such as Li, Na, K, and Cu) thereof; monohydric, dihydric, trihydric, tetrahydric, pentahydric or hexahydric alcohols with 12 to 22 carbon atoms (which may contain an unsaturated bond or be branched); alkoxy alcohols with 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty acid esters of monoalkyl ethers of alkylene oxide polymers; fatty acid amides with 8 to 22 carbon atoms; and aliphatic amines with 8 to 22 carbon atoms.

Specific examples of the additives in the form of fatty acids are: capric acid, caprylic acid, lauric acid, myristic acid, palmitic acid, stearic acid, behenic acid, oleic acid, elaidic acid, linolic acid, linolenic acid, and isostearic acid. Examples of esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentylglycol didecanoate, and ethylene glycol dioleyl. Examples of alcohols are oleyl alcohol, stearyl alcohol, and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K. K.). These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent. The total lubricant amount is normally 0.1 to 50 weight percent, preferably 2 to 25 weight percent with respect to the ferromagnetic powder.

[Nonmagnetic Layer]

The magnetic recording medium of the present invention may have a nonmagnetic layer comprising a nonmagnetic powder and a binder between the nonmagnetic support and a magnetic layer. The nonmagnetic powder comprised in the nonmagnetic layer can be selected from inorganic compounds such as metal oxides, metal carbonates, metal sulfates, metal nitrides, metal carbides, metal sulfides and the like. Examples of inorganic compounds are alpha-alumina having an alpha-conversion rate of 90 to 100 percent, beta-alumina, gamma-alumina, silicon carbide, chromium oxide, cerium oxide, alpha-iron oxide, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate and molybdenum disulfide; these may be employed singly or in combination. Particularly desirable are titanium dioxide, zinc oxide, iron oxide and barium sulfate. Even more preferred is titanium dioxide.

The mean particle diameter of these nonmagnetic powders preferably ranges from 0.005 to 2 micrometers, but nonmagnetic powders of differing particle size may be combined as needed, or the particle diameter distribution of a single nonmagnetic powder may be broadened to achieve the same effect. What is preferred most is a mean particle diameter in the nonmagnetic powder ranging from 0.01 to 0.2 micrometer. The pH of the nonmagnetic powder particularly preferably ranges from 6 to 9. The specific surface area of the nonmagnetic powder preferably ranges from 1 to 100 m²/g, more preferably from 5 to 50 m²/g, further preferably from 7 to 40 m²/g. The crystallite size of the nonmagnetic powder preferably ranges from 0.01 micrometer to 2 micrometers, the oil absorption capacity using dibutyl phthalate (DBP) preferably ranges from 5 to 100 ml/100 g, more preferably from 10 to 80 ml/100 g, further preferably from 20 to 60 ml/100 g. The specific gravity preferably ranges from 1 to 12, more preferably from 3 to 6. The shape of the nonmagnetic powder may be any of acicular, spherical, polyhedral, or plate-shaped.

The surface of these nonmagnetic powders is preferably treated with Al₂O₃, SiO₂, TiO₂, ZrO₂, SnO₂, Sb₂O₃ and ZnO. The surface-treating agents of preference with regard to dispersibility are Al₂O₃, SiO₂, TiO₂ and ZrO₂, and Al₂O₃, SiO₂ and ZrO₂ are further preferable. These may be used singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Carbon black can be added to the nonmagnetic layer. Mixing carbon black achieves the known effects of lowering surface electrical resistivity Rs and yielding the desired micro Vickers hardness. Examples of types of carbon black that are suitable for use are furnace black for rubber, thermal for rubber, black for coloring and acetylene black. The specific surface area of carbon black employed preferably ranges from 100 to 500 m²/g, more preferably from 150 to 400 m²/g, and the DBP oil absorption capacity preferably ranges from 20 to 400 ml/100 g, more preferably from 30 to 200 ml/100 g. The mean particle diameter of carbon black preferably ranges from 5 to 80 nm (5 to 80 mμ), more preferably from 10 to 50 nm (10 to 50 mμ), further preferably from 10 to 40 nm (10 to 40 mμ). It is preferable for carbon black that the pH ranges from 2 to 10, the moisture content ranges from 0.1 to 10 percent and the tap density ranges from 0.1 to 1 g/ml. Specific examples of types of carbon black suitable for use are: BLACK PEARLS 2000, 1300, 1000, 900, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Lion Akzo Co., Ltd.

As regards binders, lubricants, dispersants, additives, solvents, dispersion methods and the like of the nonmagnetic layer, known techniques regarding magnetic layers can be applied. In particular, known techniques for magnetic layers regarding types and amounts of binders, additives and dispersants can be applied to the nonmagnetic layer.

The nonmagnetic layer can be formed by coating the nonmagnetic layer coating liquid prepared by the aforementioned materials onto a nonmagnetic support.

All or some of the additives used in the present invention may be added at any stage in the process of manufacturing the magnetic and nonmagnetic coating liquids. For example, they may be mixed with the ferromagnetic powder before a kneading step; added during a step of kneading the ferromagnetic powder, the binder, and the solvent; added during a dispersing step; added after dispersing; or added immediately before coating. Part or all of the additives may be applied by simultaneous or sequential coating after the magnetic layer has been applied to achieve a specific purpose. Depending on the objective, the lubricant may be coated on the surface of the magnetic layer after calendering or making slits. Known organic solvents may be employed in the present invention. For example, the solvents described in Japanese Unexamined Patent Publication (KOKAI) Showa No. 6-68453 may be employed.

[Layer Structure]

In the magnetic recording medium of the present invention, the thickness of the nonmagnetic support preferably ranges from 2 to 100 micrometers, more preferably from 2 to 80 micrometers. For computer-use magnetic recording tapes, the nonmagnetic support having a thickness of 3.0 to 6.5 micrometers, preferably 3.0 to 6.0 micrometers, more preferably 4.0 to 5.5 micrometers is suitably employed.

An undercoating layer may be provided to improve adhesion between the nonmagnetic support and the nonmagnetic layer or magnetic layer. The thickness of the undercoating layer can be made from 0.01 to 0.5 micrometer, preferably from 0.02 to 0.5 micrometer. The magnetic recording medium of the present invention may be a disk-shaped medium in which a nonmagnetic layer and magnetic layer are provided on both sides of the nonmagnetic support, or may be a tape-shaped or disk-shaped magnetic recording medium having these layers on just one side. In the latter case, a backcoat layer may be provided on the opposite surface of the nonmagnetic support from the surface on which is provided the magnetic layer to achieve effects such as preventing static and compensating for curl. The thickness of the backcoat layer is, for example, from 0.1 to 4 micrometers, preferably from 0.3 to 2.0 micrometers. Known undercoating layers and backcoat layers may be employed.

In the magnetic recording medium of the present invention, the thickness of the magnetic layer can be optimized based on the saturation magnetization of the head employed, the length of the head gap, and the recording signal band, and is preferably 10 to 100 nm, more preferably 30 to 80 nm. The magnetic layer may be divided into two or more layers having different magnetic characteristics, and a known configuration relating to multilayered magnetic layer may be applied.

The nonmagnetic layer is normally 0.2 to 5.0 micrometers, preferably 0.3 to 3.0 micrometers, and more preferably, 1.0 to 2.5 micrometers in thickness. The nonmagnetic layer exhibits its effect so long as it is substantially nonmagnetic. For example, the effect of the present invention is exhibited even when trace quantities of magnetic material are incorporated as impurities or intentionally incorporated, and such incorporation can be viewed as substantially the same configuration as the present invention.

[Backcoat Layer]

Generally, computer data recording-use magnetic tapes are required to have far better repeat running properties than audio and video tapes. Carbon black and inorganic powders are desirably incorporated into the backcoat layer to maintain high ruing durability.

Two types of carbon black of differing mean particle diameter are desirably combined for use. In this case, microparticulate carbon black with a mean particle diameter of 10 to 50 nm and coarse particulate carbon black with a mean particle diameter of 70 to 300 nm are desirably combined for use. Generally, the addition of such microparticulate carbon black makes it possible to set a lower surface electrical resistance and optical transmittance in the backcoat layer. Many magnetic recording devices exploit the optical transmittance of the tape in an operating signal. In such cases, the addition of microparticulate carbon black is particularly effective. Microparticulate carbon black generally enhances liquid lubricant retentivity, contributing to a reduced coefficient of friction when employed with lubricants.

Examples of specific microparticulate carbon black products are given below and the mean particle diameter is given in parentheses: BLACK PEARLS 800 (17 nm), BLACK PEARLS 1400 (13 nm), BLACK PEARLS 1300 (13 nm), BLACK PEARLS 1100 (14 nm), BLACK PEARLS 1000 (16 nm), BLACK PEARLS 900 (15 nm), BLACK PEARLS 880 (16 nm), BLACK PEARLS 4630 (19 nm), BLACK PEARLS 460 (28 nm), BLACK PEARLS 430 (28 nm), BLACK PEARLS 280 (45 nm), MONARCH 800 (17 nm), MONARCH 14000 (13 nm), MONARCH 1300 (13 nm), MONARCH 1100 (14 nm), MONARCH 1000 (16 nm), MONARCH 900 (15 nm), MONARCH 880 (16 nm), MONARCH 630 (19 nm), MONARCH 430 (28 nm), MONARCH 280 (45 nm), REGAL 330 (25 nm), REGAL 250 (34 nm), REGAL 99 (38 nm), REGAL 400 (25 nm) and REGAL 660(24 nm) from Cabot Corporation; RAVEN2000B (18 nm), RAVEN1500B (17 nm), Raven 7000 (11 nm), Raven 5750 (12 nm), Raven 5250 (16 nm), Raven 3500 (13 nm), Raven 2500 ULTRA (13 nm), Raven 2000 (18 nm), Raven 1500 (17 nm), Raven 1255 (21 nm), Raven 1250 (20 nm), Raven 1190 ULTRA (21 nm), Raven 1170 (21 nm), Raven 1100 ULTRA (32 nm), Raven 1080 ULTRA (28 nm), Raven 1060 ULTRA (30 nm), Raven 1040 (28 nm), Raven 880 ULTRA (30 nm), Raven 860 (39 nm), Raven 850 (34 nm), Raven 820 (32 nm), Raven 790 ULTRA (30 nm), Raven 780 ULTRA (29 nm) and Raven 760 ULTRA (30 nm) from Columbia Carbon Co., Ltd.; Asahi #90 (19 nm), Asahi #80 (22 nm), Asahi #70 (28 nm), Asahi F-200 (35 nm), Asahi #60HN (40 nm), Asahi #60 (45 nm), HS-500 (38 nm) and Asahi #51 (38 nm) from Asahi Carbon Co., Ltd.; #2700 (13 nm), #2650 (13 nm), #2400 (14 nm), #1000 (18 nm), #950 (16 nm), #850 (17 nm), #750 (22 nm), #650 (22 nm), #52 (27 nm), #50 (28 nm), #40 (24 nm), #30 (30 nm), #25 (47 nm), #95 (40 nm) and CF9 (40 nm) from Mitsubishi Chemical Corporation; PRINNTEX 90 (14 nm), PRINTEX 95 (15 nm), PRINTEX 85 (16 nm), PRINTEX 75 (17 nm) from Degussa; #3950 (16 nm) from Mitsubishi Chemical Corporation.

Examples of specific coarse particulate carbon black products are given below: BLACK PEARLS 130 (75 nm), MONARCH 120 (75 nm) and Regal 99 (100 nm) from Cabot Corporation; Raven 450 (75 nm), Raven 420 (86 nm), Raven 410 (101 nm), Raven 22 (83 nm) and RAVEN MTP (275 nm) from Columbia Carbon Co., Ltd.; Asahi 50H (85 nm), Asahi #51 (91 nm), Asahi #50 (80 nm), Asahi #35 (78 nm) and Asahi #15 (122 nm) from Asahi Carbon Co., Ltd.; #10 (75 nm), #5 (76 nm) and #4010 (75 nm) from Mitsubishi Chemical Corporation; Thermal black (270 nm) from Cancarb Limited.

When employing two types of carbon black having different mean particle diameters in the backcoat layer, the ratio (by weight) of the content of microparticulate carbon black of 10 to 50 nm to that of coarse particulate carbon black of 70 to 300 nm preferably ranges from 100:0.5 to 100:100, more preferably from 100:1 to 100:50.

The content of carbon black in the backcoat layer (the total quantity when employing two types of carbon black) normally ranges from 30 to 100 weight parts, preferably 45 to 95 weight parts, per 100 weight parts of binder.

Two types of inorganic powder of differing hardness are desirably employed in combination. Specifically, a soft inorganic powder with a Mohs' hardness of 3 to 4.5 and a hard inorganic powder with a Mohs' hardness of 5 to 9 are desirably employed. The addition of a soft inorganic powder with a Mohs' hardness of 3 to 4.5 permits stabilization of the coefficient of friction during repeat running. Within the stated range, the sliding guide poles are not worn down. The mean particle diameter of the soft inorganic powder desirably ranges from 30 to 50 nm.

Examples of soft organic powders having a Mohs' hardness of 3 to 4.5 are calcium sulfate, calcium carbonate, calcium silicate, barium sulfate, magnesium carbonate, zinc carbonate, and zinc oxide. These may be employed singly or in combinations of two or more.

The content of the soft inorganic powder in the backcoat layer preferably ranges from 10 to 140 weight parts, more preferably 35 to 100 weight parts, per 100 weight parts of carbon black.

The addition of a hard inorganic powder with a Mohs' hardness of 5 to 9 increases the strength of the backcoat layer and improves running durability. When the hard inorganic powder is employed with carbon black and the above-described soft inorganic powder, deterioration due to repeat sliding is reduced and a strong backcoat layer is obtained. The addition of the hard inorganic powder imparts suitable abrasive strength and reduces adhesion of scrapings onto the tape guide poles and the like. Particularly when employed with a soft inorganic powder, sliding characteristics on guide poles with rough surface are enhanced and the coefficient of friction of the backcoat layer can be stabilized. The mean particle diameter of the hard inorganic powder preferably ranges from 80 to 250 nm, more preferably 100 to 210 nm.

Examples of hard inorganic powders having a Mohs' hardness of 5 to 9 are alpha-iron oxide, alpha-alumina, and chromium oxide (Cr₂O₃). These powders may be employed singly or in combination. Of these, alpha-iron oxide and alpha-alumina are preferred. The content of the hard inorganic powder is normally 3 to 30 weight parts, preferably 3 to 20 weight parts, per 100 weight parts of carbon black.

When employing the above-described soft inorganic powder and hard inorganic powder in combination in the backcoat layer, the soft inorganic powder and the hard inorganic powder are preferably selected so that the difference in hardness between the two is equal to or greater than 2 (more preferably equal to or greater than 2.5, further preferably equal to or greater than 3). The backcoat layer desirably comprises the above two types of inorganic powder having the above-specified mean particle sizes and difference in Mohs' hardness and the above two types of carbon black of the above-specified mean particle sizes.

The backcoat layer may also contain a lubricant. The lubricant may be suitably selected from among the lubricants given as examples above for use in the nonmagnetic layer and magnetic layer. The lubricant is normally added to the backcoat layer in a proportion of 1 to 5 weight parts per 100 weight parts of binder.

[Nonmagnetic Support]

Known films of the following may be employed as the nonmagnetic support in the present invention: polyethylene terephthalate, polyethylene naphthalate and other polyesters, polyolefins, cellulose triacetate, polycarbonate, polyamides, polyimides, polyamidoimides, polysulfones, aromatic polyamides, polybenzooxazoles and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127 may be employed to vary the surface roughness of the magnetic surface and support surface. These supports may be subjected beforehand to corona discharge treatment, plasma treatment, adhesion enhancing treatment, heat treatment, dust removal, and the like.

The center surface average surface roughness (SRa) of the support measured with an optical interferotype surface roughness meter HD-2000 made by WYKO is preferably equal to or less than 8.0 nm, more preferably equal to or less than 4.0 nm, further preferably equal to or less than 2.0 nm. Not only does such a support desirably have a low center surface average surface roughness, but there are also desirably no large protrusions equal to or higher than 0.5 micrometer. The surface roughness shape may be freely controlled through the size and quantity of filler added to the support as needed. Examples of such fillers are oxides and carbonates of elements such as Ca, Si, and Ti, and organic fine powders such as acrylic-based one. The support desirably has a maximum height Rₘₐₓ equal to or less than 1 micrometer, a ten-point average roughness R_{Z} equal to or less than 0.5 micrometer, a center surface peak height R_{P} equal to or less than 0.5 micrometer, a center surface valley depth R_{V} equal to or less than 0.5 micrometer, a center-surface surface area percentage Sr of 10 percent to 90 percent, and an average wavelength lambdaₐ of 5 to 300 micrometers. To achieve desired electromagnetic characteristics and durability, the surface protrusion distribution of the support can be freely controlled with fillers. It is possible to control within a range from 0 to 2,000 protrusions of 0.01 to 1 micrometer in size per 0.1 mm².

The F-5 value of the nonmagnetic support employed in the present invention desirably ranges from 5 to 50 kg/mm², approximately 49 to 490 MPa. The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm², approximately 49 to 980 MPa. The modulus of elasticity preferably ranges from 100 to 2,000 kg/mm², approximately 0.98 to 19.6 GPa. The thermal expansion coefficient preferably ranges from 10⁻⁴ to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

[Manufacturing Method]

The process for manufacturing coating liquids for magnetic and nonmagnetic layers comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. When a kneader is employed, the ferromagnetic powder or nonmagnetic powder and all or part of the binder (preferably equal to or higher than 30 weight percent of the entire quantity of binder) can be kneaded in a range of 15 to 500 parts per 100 parts of the ferromagnetic powder. Details of the kneading process are described in Japanese Unexamined Patent Publication (KOKAI) Heisei Nos. 1-106338 and 1-79274. Further, glass beads may be employed to disperse the coating liquids for magnetic and nonmagnetic layers, with a dispersing medium with a high specific gravity such as zirconia beads, titania beads, and steel beads being suitable for use. The particle diameter and fill ratio of these dispersing media are optimized for use. A known dispersing device may be employed.

When coating a magnetic recording medium of multilayer configuration in the present invention, the use of a wet-on-dry method in which a coating liquid for forming a nonmagnetic layer is coated on the nonmagnetic support and dried to form a nonmagnetic layer, and then a coating liquid for forming a magnetic layer is coated on the nonmagnetic layer and dried. With this method, the thickness variation of the magnetic layer can be reduced to improve the S/N ratio. Therefore, this method is suitable for manufacturing a high-density magnetic recording medium.

When using a wet-on-wet method in which a coating liquid for forming a nonmagnetic layer is coated, and while this coating is still wet, a coating liquid for forming a magnetic layer is coated thereover and dried, the following methods are desirably employed;

(1) a method in which the nonmagnetic layer is first coated with a coating device commonly employed to coat magnetic coating materials such as a gravure coating, roll coating, blade coating, or extrusion coating device, and the magnetic layer is coated while the nonmagnetic layer is still wet by means of a support pressure extrusion coating device such as is disclosed in Japanese Examined Patent Publication (KOKOKU) Heisei No. 1-46186 and Japanese Unexamined Patent Publication (KOKAI) Showa No. 60-238179 and Japanese Unexamined Patent Publication (KOKAI) Heisei No. 2-265672;

(2) a method in which the upper and lower layers are coated nearly simultaneously by a single coating head having two built-in slits for passing coating liquid, such as is disclosed in Japanese Unexamined Patent Publication (KOKAI) Showa No. 63-88080, Japanese Unexamined Patent Publication (KOKAI) Heisei No. 2-17971, and Japanese Unexamined Patent Publication (KOKAI) Heisei No. 2-265672; and

(3) a method in which the upper and lower layers are coated nearly simultaneously using an extrusion coating apparatus with a backup roller as disclosed in Japanese Unexamined Patent Publication (KOKAI) Heisei No. 2-174965. To avoid deteriorating the electromagnetic characteristics or the like of the magnetic recording medium by aggregation of magnetic particles, shear is desirably imparted to the coating liquid in the coating head by a method such as disclosed in Japanese Unexamined Patent Publication (KOKAI) Showa No. 62-95174 or Japanese Unexamined Patent Publication (KOKAI) Heisei No. 1-236968. In addition, the viscosity of the coating liquid preferably satisfies the numerical range specified in Japanese Unexamined Patent Publication (KOKAI) Heisei No. 3-8471.

When providing the intermediate layer between the nonmagnetic layer and the magnetic layer as mentioned above, the magnetic recording medium can be formed by first coating a nonmagnetic layer coating liquid on a nonmagnetic support and drying it, next coating an intermediate layer coating liquid on the nonmagnetic layer and then drying and curing it with radiation, finally coating a magnetic layer coating liquid thereover and drying it. By coating three layers sequentially in this manner, nonmagnetic layer surface roughness and protrusions can be masked with the intermediate layer to obtain a magnetic layer having high smoothness. When providing the intermediate layer on the nonmagnetic support, the magnetic recording medium can be formed by first coating an intermediate layer coating liquid on a nonmagnetic support and then drying and curing it with radiation, and if necessary, forming the nonmagnetic layer by coating and drying a nonmagnetic layer coating liquid, finally coating a magnetic layer coating liquid thereover and drying it. By coating the intermediate layer, nonmagnetic layer and magnetic layer sequentially in this manner, the surface roughness and protrusions on the nonmagnetic support or the nonmagnetic layer can be masked with the intermediate layer to obtain a magnetic layer having high smoothness. Coating of coating liquid for each layer can be carried out with a coating device commonly employed to coat magnetic coating materials such as a gravure coating, roll coating, blade coating, or extrusion coating device.

The magnetic recording medium that has been coated and dried as mentioned above is normally calendered. The calendering rolls employed may be in the form of heat-resistant plastic rolls, such as epoxy, polyimide, polyamide, and polyimidoamide rolls, or in the form of metal rolls. Processing with metal rolls is particularly desirable for magnetic recording media in which magnetic layers are provided on both sides. The processing temperature is preferably equal to or greater than 50° C., more preferably equal to or greater than 100° C. The linear pressure is preferably equal to or greater than 200 kg/cm, approximately 196 kN/m, more preferably equal to or greater than 300 kg/cm, approximately 294 kN/m.

[Physical Characteristics]

The coefficient of friction of the magnetic recording medium of the present invention relative to the head is preferably equal to or less than 0.5 and more preferably equal to or less than 0.3 at temperatures ranging from −10° C. to 40° C. and humidity ranging from 0 percent to 95 percent, the surface resistivity on the magnetic surface preferably ranges from 10⁴ to 10¹² ohm/sq, and the charge potential preferably ranges from −500 V to +500 V. The modulus of elasticity at 0.5 percent extension of the magnetic layer preferably ranges from 100 to 2,000 kg/mm², approximately 980 to 19,600 MPa, in each in-plane direction. The breaking strength preferably ranges from 10 to 70 kg/mm², approximately 98 to 686 MPa. The modulus of elasticity of the magnetic recording medium preferably ranges from 100 to 1,500 kg/mm², approximately 980 to 14,700 MPa, in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent. The glass transition temperature (i.e., the temperature at which the loss elastic modulus of dynamic viscoelasticity peaks as measured at 110 Hz) of the magnetic layer preferably ranges from 50 to 120° C., and that of the nonmagnetic layer preferably ranges from 0 to 100° C. The loss elastic modulus preferably falls within a range of 1×10³ to 8×10⁴ N/cm² and the loss tangent is preferably equal to or less than 0.2. Adhesion failure tends to occur when the loss tangent becomes excessively large. These thermal characteristics and mechanical characteristics are desirably nearly identical, varying by 10 percent or less, in each in-plane direction of the medium. The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object.

The surface roughness Ra of the magnetic layer is preferably equal to or less than 2 nm, more preferably 1.2 to 1.8 nm, as mentioned above. The maximum height Rₘₐₓ of the magnetic layer is preferably equal to or less than 0.5 micrometer, the ten-point average surface roughness R_{Z} is preferably equal to or less than 0.3 micrometer, the center surface peak height R_{P} is preferably equal to or less than 0.3 micrometer, the center surface valley depth R_{V} is preferably equal to or less than 0.3 micrometer, the center-surface surface area percentage Sr preferably ranges from 20 percent to 80 percent, and the average wavelength lambdaₐ preferably ranges from 5 to 300 micrometers. On the surface of the magnetic layer, it is possible to freely control the number of surface protrusions of 0.01 to 1 micrometer in size within a range from 0 to 2,000 per 0.1 mm² to optimize electromagnetic characteristics and the coefficient of friction. These can be readily achieved by controlling surface properties through the filler used in the support, by controlling the particle diameter and quantity of the powder added to the magnetic layer, and by controlling the roll surface configuration in calendar processing. Curling is preferably controlled to within ±3 mm.

When the magnetic recording medium of the present invention has a nonmagnetic layer and magnetic layer, it will be readily deduced that the physical properties of the nonmagnetic layer and magnetic layer may be varied based on the objective. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

The present invention provides a magnetic recording medium exhibiting excellent electromagnetic characteristics, error rate and durability in high-density recording and reproduction systems in which a signal recorded in short bit lengths is reproduced by MR heads with a narrow read track width. Specifically, the minimum bit length of the signal recorded on the magnetic recording medium of the present invention can be equal to or less than 100 nm, for example, or even equal to or less than 80 nm. The lower limit of the minimum bit length can be set to 20 nm, for example. Further, the read track width of the MR heads used to reproduce a signal recorded on the magnetic recording medium of the present invention can be equal to or less than 2,500 nm, even equal to or less than 1,500 nm. The lower limit of the read track width can be set to 200 nm, for example.

### EXAMPLES

The present invention will be described in detail below based on examples. However, the present invention is not limited to the examples. Further, “parts” given in Examples are weight parts unless specifically stated otherwise.

### Example 1

| (Magnetic layer coating liquid) | | |
|---|---|---|
| Magnetic powder: Barium ferrite | 100 | parts |
| (mean plate diameter 30 nm) | | |
| Vinyl chloride copolymer | 5 | parts |
| MR110 manufactured by Nippon Zeon Co., Ltd. | | |
| Polyurethane resin | 3 | parts |
| UR8200 manufactured by Toyobo Co., Ltd. | | |
| Curing agent | 5 | parts |
| Coronate L manufactured by Nippon Polyurethane | | |
| Industry Co. Ltd. | | |
| Abrasive: TiC | 4 | parts |
| Carbon black | 1 | part |
| #50 manufactured by Asahi Carbon Co., Ltd. | | |
| Phenylphosphonic acid | 2 | parts |
| Butyl stearate | 10 | parts |
| Butoxyethyl stearate | 5 | parts |
| Isohexadecyl stearate | 3 | parts |
| Stearic acid | 2 | parts |
| Methyl ethyl ketone | 125 | parts |
| Cyclohexanone | 125 | parts |
| (Nonmagnetic layer coating liquid) | | |
| Nonmagnetic powder: Fe₂O₃ | 80 | parts |
| Mean primary particle diameter: 0.15 micrometer | | |
| Specific surface area by BET method: 60 m²/g | | |
| Surface treatment agent: Al₂O₃ (8 weight percent) | | |
| CONDUCTEX SC-U manufactured by Columbia | 20 | parts |
| Carbon Co., Ltd. | | |
| MR110 manufactured by Nippon Zeon Co., Ltd. | 12 | parts |
| Vylon UR8200 manufactured by Toyobo Co., Ltd. | 5 | parts |
| Butyl stearate | 1 | part |
| Butoxyethyl stearate | 1 | part |
| Isohexadecyl stearate | 3 | parts |
| Stearic acid | 3 | parts |
| Methyl ethyl ketone/Cyclohexanone (8/2 mixed solvent) | 250 | parts |

After kneading the components of the above-described coating liquid, ZrO₂ with a mean particle diameter of 10 micrometers was admixed with the above kneaded mass and dispersed in a sand mill. The quantity of ZrO₂ admixed was 5 times the weight of the kneaded mass. The dispersions obtained were then filtered through filters having average pore diameters of 5 micrometers and 1 micrometer to prepare a magnetic layer coating liquid and a nonmagnetic layer coating liquid. The intermediate layer coating liquid was coated to a thickness of 0.5 micrometer on a PET support 6 micrometers in thickness with a centerline average surface roughness of 3 nm, and curing was conducted with a 5 Mrad absorbed dose using an electron beam irradiating device. Then, on the intermediate layer thus formed, the nonmagnetic layer coating liquid was coated in a quantity calculated to yield a dry thickness of 1.5 micrometers. The magnetic layer coating liquid was then applied; subjected to a longitudinal orientation treatment by passage through a magnetic field with an intensity of 0.3 T (3,000 G) while still wet; and dried. The roll was then treated with a seven-stage calender at 90° C. at a linear pressure of 300 kg/cm (294 kN/m). Next, the roll was slit to a width of ½ inch and demagnetized by passage through a solenoid having a magnetic flux density of 0.3 T (3,000 G).

(Intermediate Layer Coating Liquid)

The following components were mixed and stirred to prepare an intermediate layer coating liquid.

| | |
|---|---|
| DPE6A (EB curing resin manufactured by | 100 parts |
| Kyoeisha Chemical Co., Ltd.) | |
| Dipentaerythritol hexaacrylate | |
| Viscosity: 6000 mPa/sec | |
| Methyl ethyl ketone | 400 parts |

### Example 2

With the exception that CBN was employed instead of TiC as the abrasive added to the magnetic layer, a magnetic tape was prepared by the same method as in Example 1.

### Example 3

With the exception that SiC was employed instead of TiC as the abrasive added to the magnetic layer, a magnetic tape was prepared by the same method as in Example 1.

### Example 4

With the exception that the mean particle diameter of the abrasive added to the magnetic layer was changed as indicated in Table 1, a magnetic tape was prepared by the same method as in Example 3.

### Example 5

With the exception that the quantity of abrasive added to the magnetic layer was changed as indicated in Table 1, a magnetic tape was prepared by the same method as in Example 3.

### Example 6

With the exception that the quantity of abrasive added to the magnetic layer was changed as indicated in Table 1, a magnetic tape was prepared by the same method as in Example 3.

### Example 7

With the exception that the thickness of the magnetic layer and the quantity of abrasive added to the magnetic layer were changed as indicated in Table 1, a magnetic tape was prepared by the same method as in Example 3.

### Example 8

With the exception that the thickness of the magnetic layer and the quantity of abrasive added to the magnetic layer were changed as indicated in Table 1, a magnetic tape was prepared by the same method as in Example 3.

### Example 9

With the exception that the mixing ratio of ZrO₂ with a mean particle diameter of 10 micrometers and the kneaded mass during dispersion of the magnetic layer liquid was changed from 1:5 to 1:2 and the mean particle diameter of the abrasive added to the magnetic layer and the minimum recorded bit length were changed as indicated in Table 1, a magnetic tape was prepared as in Example 3.

### Example 10

With the exception that no intermediate layer was provided, a magnetic tape was prepared by the same method as in Example 3.

### Example 11

With the exception that the magnetic powder employed was changed to barium ferrite with a mean plate diameter of 50 nm, a magnetic tape was prepared by the same method as in Example 3.

### Example 12

With the exception that the minimum bit length and head read track width were changed as shown in Table 1, the same procedure was followed as in Example 3.

### Example 13

With the exception that the head read track width was changed as indicated in Table 1, the same procedure was followed as in Example 3.

### Comparative Example 1

With the exception that Al₂O₃ was employed instead of SiC as the abrasive added to the magnetic layer, a magnetic tape was prepared by the same method as in Example 1.

### Comparative Example 2

With the exception that SiC with a mean particle diameter of 150 nm was employed as the abrasive added to the magnetic layer, a magnetic tape was prepared by the same method as in Example 1.

### Comparative Example 3

With the exception that the quantity of abrasive added to the magnetic layer was changed as indicated in Table 1, a magnetic tape was prepared by the same method as in Example 3.

### Comparative Example 4

With the exception that the quantity of abrasive added to the magnetic layer was changed as indicated in Table 1, a magnetic tape was prepared by the same method as in Example 3.

### Comparative Example 5

With the exception that the processing time of the magnetic liquid and abrasive was reduced to ⅓, a magnetic tape was prepared by the same method as in Example 4.

Evaluation Methods

(1) SNR

SNR was measured with a ½ inch Drum tester upon which heads were secured. A relative speed of tape against head was 10 m/s. Recording was conducted with a saturation magnetization (1.3 T) MIG head (gap length 0.15 micrometer, track width 1.0 micrometer). The recording current was set to the optimal recording current for each tape. GMR heads with an element thickness of 15 nm and shield spacing (0.1 micrometer) were employed as the reproduction heads. The S/N ratio was obtained by recording a signal with a linear recording density of 180 KFci, frequency analyzing the reproduced signal with a spectrum analyzer made by Shibasoku, and calculating the S/N ratio as the ratio of the carrier signal output to the integrated noise of the full spectral band. The minimum bit length of the signal recorded and the read track width of the reproduction head in Examples and Comparative Examples are given in Table 1.

(2) Still Life

The still life was calculated as the time required for the initial value to drop 6 dB when monitoring the output while pressing the tape against the head in the above measurement.

(3) Head Abrasion

To evaluate head abrasion, a tape was pressed with a tension of 1 N against the triangular Al₂O₃TiC rod of a head member, 500 m of tape was passed 100 times at a rate of 10 m/s, and the width cut into the triangle was denoted as a relative value taking the value of Example 1 as a reference value.

(4) Number of Abrasive Present on the Surface of the Magnetic Layer

The number of abrasive present on the surface of the magnetic layer was obtained by measurement through observation of the surface by scanning electron microscopy at a low voltage of equal to or lower than 5 kV.

(5) Magnetic Layer Surface Roughness Ra

The magnetic layer surface roughness Ra was measured with a NANO SCOPE 3 made by Veeco Instruments.

TABLE 1

| | | Abrasive | | |
|---|---|---|---|---|
| | Magnetic layer thickness | | Mean particle | Quantity added |
| | (nm) | Vickers hardness (GPa)/type | diameter (nm) | (parts) |
| Example 1 | 70 | 18/TiC | 50 | 30 |
| Example 2 | 70 | 80/CBN | 50 | 30 |
| Example 3 | 70 | 25/SiC | 50 | 30 |
| Example 4 | 70 | 25/SiC | 100 | 30 |
| Example 5 | 70 | 25/SiC | 50 | 60 |
| Example 6 | 70 | 25/SiC | 50 | 5 |
| Example 7 | 100 | 25/SiC | 50 | 60 |
| Example 8 | 45 | 25/SiC | 50 | 5 |
| Example 9 | 70 | 25/SiC | 100 | 30 |
| Example 10 | 70 | 25/SiC | 50 | 30 |
| Example 11 | 70 | 25/SiC | 50 | 30 |
| Example 12 | 70 | 25/SiC | 50 | 30 |
| Example 13 | 70 | 25/SiC | 50 | 30 |
| Comp. Ex. 1 | 70 | 15/Al₂O₃ | 50 | 30 |
| Comp. Ex. 2 | 70 | 25/SiC | 150 | 30 |
| Comp. Ex. 3 | 70 | 25/SiC | 50 | 3 |
| Comp. Ex. 4 | 70 | 25/SiC | 50 | 75 |
| Comp. Ex. 5 | 70 | 25/SiC | 100 | 30 |

| | | Number of abrasive/ | |
|---|---|---|---|
| | Minimum bit length (nm) | minimum bit area (μm²)^{⊕} | Particle diameter/minimum bit length |
| Example 1 | 70 | 0.2 | 0.71 |
| Example 2 | 70 | 0.2 | 0.71 |
| Example 3 | 70 | 0.2 | 0.71 |
| Example 4 | 70 | 0.05 | 1.43 |
| Example 5 | 70 | 0.4 | 0.71 |
| Example 6 | 70 | 0.0167 | 0.71 |
| Example 7 | 70 | 1 | 0.71 |
| Example 8 | 70 | 0.01 | 0.71 |
| Example 9 | 45 | 0.01 | 2.22 |
| Example 10 | 70 | 0.2 | 0.71 |
| Example 11 | 70 | 0.2 | 0.71 |
| Example 12 | 140 | 0.2 | 0.42 |
| Example 13 | 70 | 0.2 | 0.71 |
| Comp. Ex. 1 | 70 | 0.2 | 0.71 |
| Comp. Ex. 2 | 70 | 0.2 | 2.1 |
| Comp. Ex. 3 | 70 | 0.2 | 0.71 |
| Comp. Ex. 4 | 70 | 0.2 | 0.71 |
| Comp. Ex. 5 | 70 | 0.005 | 1.35 |

| | | | | | | Head abrasion |
|---|---|---|---|---|---|---|
| | Ra (nm) | Magnetic material | Head read track width | SNR(2T) | Still life | (relative value) |
| Example 1 | 1.5 | 30 nmBaFe | 1 μm | 20 | 4 hours or more | 1 |
| Example 2 | 1.5 | 30 nmBaFe | 1 μm | 21 | 4 hours or more | 2 |
| Example 3 | 1.5 | 30 nmBaFe | 1 μm | 21 | 4 hours or more | 1 |
| Example 4 | 1.5 | 30 nmBaFe | 1 μm | 18 | 4 hours or more | 0.5 |
| Example 5 | 1.5 | 30 nmBaFe | 1 μm | 18 | 4 hours or more | 1.4 |
| Example 6 | 1.5 | 30 nmBaFe | 1 μm | 25 | 4 hours or more | 0.8 |
| Example 7 | 1.5 | 30 nmBaFe | 1 μm | 22 | 4 hours or more | 2.4 |
| Example 8 | 1.5 | 30 nmBaFe | 1 μm | 17 | 4 hours or more | 0.2 |
| Example 9 | 1.5 | 30 nmBaFe | 1 μm | 15 | 4 hours or more | 0.1 |
| Example 10 | 2.5 | 30 nmBaFe | 1 μm | 15 | 4 hours or more | 1 |
| Example 11 | 1.5 | 50 nmBaFe | 1 μm | 14 | 4 hours or more | 1 |
| Example 12 | 1.5 | 30 nmBaFe | 0.5 μm | 17 | 4 hours or more | 1 |
| Example 13 | 1.5 | 30 nmBaFe | 3 μm | *18 | 4 hours or more | 1 |
| Comp. Ex. 1 | 1.5 | 30 nmBaFe | 1 μm | 20 | 2 minutes | 0.02 |
| Comp. Ex. 2 | 1.5 | 30 nmBaFe | 1 μm | 12 | 4 hours or more | 5 |
| Comp. Ex. 3 | 1.5 | 30 nmBaFe | 1 μm | 12 | 1 minute or less | 0.1 |
| Comp. Ex. 4 | 1.5 | 30 nmBaFe | 1 μm | 11 | 4 hours or more | 6 |
| Comp. Ex. 5 | 1.5 | 30 nmBaFe | 1 μm | 18 | 20 minutes | 4 |

Minimum bit area = (minimum bit length) × (read track width)
*The value was cauculated by subtracting 4.8 dB from the actual measurement value because the surface recording density was ⅓.

Evaluation Results

The magnetic tapes of Examples 1 to 13—in which the abrasive having a Vickers hardness of 18 to 80 GPa and a mean particle diameter of 10 to 100 nm was added to a magnetic layer 10 to 100 nm in thickness in a quantity of 5 to 60 weight parts per 100 weight parts of ferromagnetic powder, and the number of abrasive present on the surface of the magnetic layer was controlled to 0.01 to 1 per {(minimum bit length of the recorded signal)×(read track width of the reproduction head)} micrometer²—all exhibited good S/N ratios, good still life, and little head abrasion.

By contrast, the magnetic tape of Comparative Example 1, in which the abrasive with a Vickers hardness of 15 GPa was employed, exhibited a good S/N ratio and little head abrasion, but had poor still life.

Further, the magnetic tape of Comparative Example 2, in which the abrasive with a mean particle diameter of 150 nm was employed, exhibited good still life, but had a poor S/N ratio and poor head abrasion.

The magnetic tape of Comparative Example 3, in which three parts of abrasive were added, exhibited good head abrasion, but had a poor S/N ratio and poor still life. By contrast, the magnetic tape of Comparative Example 4, in which 75 parts of abrasive were added, had good still life but a poor S/N ratio and marked head abrasion.

The magnetic tape of Comparative Example 5, in which the number of abrasive present on the surface of the magnetic layer was less than 0.01 per {(minimum bit length of the recorded signal)×(read track width of the reproduction head)} micrometer², had a good S/N ratio but poor still life and marked head abrasion.

Based on these results, it is revealed that good electromagnetic characteristics, error rate and durability can be achieved in a magnetic recording medium, especially for high-density recording having a thin magnetic layer, by adding the abrasive with a Vickers hardness of 18 to 80 GPa and a mean particle diameter falling within a range of 10 to 100 nm to the magnetic layer in a quantity of 5 to 60 weight parts per 100 weight parts of ferromagnetic powder and controlling the number of abrasive present on the surface of the magnetic layer to 0.01 to 1 per {(minimum bit length of the recorded signal)×(read track width of the reproduction head)} micrometer².

The magnetic recording medium of the present invention is suitable for use in magnetic recording and reproduction systems using MR reproduction heads.

What is claimed is:

1. A magnetic recording medium comprising a magnetic layer comprising a ferromagnetic powder, a binder and an abrasive on a nonmagnetic support, wherein
said magnetic recording medium is employed for recording a magnetic signal on the medium and reproducing the recorded signal with a reproduction head,
said abrasive has a Vickers hardness ranging from 18 to 80 GPa and a mean particle diameter ranging from 10 to 100 nm,
said magnetic layer comprises said abrasive in a quantity of 5 to 60 weight parts per 100 weight parts of the ferromagnetic powder,
said magnetic layer has a thickness ranging from 10 to 100 nm, and
the number of abrasive present on the surface of said magnetic layer ranges from 0.01 to 1 per {(minimum bit length of the recorded signal)×(read track width of the reproduction head)} micrometer².

2. The magnetic recording medium according to claim 1, wherein said abrasive has a mean particle diameter of not greater than twice the minimum bit length of said recorded signal.

3. The magnetic recording medium according to claim 1, wherein said magnetic layer has a surface roughness Ra of equal to or less than 2.0 nm.

4. The magnetic recording medium according to claim 1, wherein said ferromagnetic powder is a hexagonal ferrite powder having a mean plate diameter ranging from 10 to 40 nm or a ferromagnetic metal powder having a mean major axis length ranging from 25 to 100 nm.

5. The magnetic recording medium according to claim 1, wherein the minimum bit length of said recorded signal is equal to or less than 100 nm.

6. The magnetic recording medium according to claim 1, wherein the read track width of said reproduction head is equal to or less than 2500 nm.

7. The magnetic recording medium according to claim 1, which further comprises an intermediate layer comprising a principal component in the form of a radiation-curing resin between the nonmagnetic support and the magnetic layer.

8. The magnetic recording medium according to claim 1, which further comprises a nonmagnetic layer comprising a nonmagnetic powder and a binder between the nonmagnetic support and the magnetic layer.

9. The magnetic recording medium according to claim 8, which further comprises an intermediate layer comprising a principal component in the form of a radiation-curing resin between the nonmagnetic support and the nonmagnetic layer or the nonmagnetic layer and the magnetic layer.

10. A method of recording a magnetic signal on a magnetic recording medium and reproducing the recorded signal with a reproduction head, wherein
said magnetic recording medium comprises a magnetic layer comprising a ferromagnetic powder, a binder and an abrasive on a nonmagnetic support,
said abrasive has a Vickers hardness ranging from 18 to 80 GPa and a mean particle diameter ranging from 10 to 100 nm,
said magnetic layer comprises said abrasive in a quantity of 5 to 60 weight parts per 100 weight parts of the ferromagnetic powder,
said magnetic layer has a thickness ranging from 10 to 100 nm, and
the number of abrasive present on the surface of said magnetic layer ranges from 0.01 to 1 per {(minimum bit length of the recorded signal)×(read track width of the reproduction head)} micrometer².

11. The method according to claim 10, wherein said abrasive has a mean particle diameter of not greater than twice the minimum bit length of said recorded signal.

12. The method according to claim 10, wherein said magnetic layer has a surface roughness Ra of equal to or less than 2.0 nm.

13. The method according to claim 10, wherein said ferromagnetic powder is a hexagonal ferrite powder having a mean plate diameter ranging from 10 to 40 nm or a ferromagnetic metal powder having a mean major axis length ranging from 25 to 100 nm.

14. The method according to claim 10, wherein the minimum bit length of said recorded signal is equal to or less than 100 nm.

15. The method according to claim 10, wherein the read track width of said reproduction head is equal to or less than 2500 nm.

16. The method according to claim 10, wherein said magnetic recording medium further comprises an intermediate layer comprising a principal component in the form of a radiation-curing resin between the nonmagnetic support and the magnetic layer.

17. The method according to claim 10, wherein said magnetic recording medium further comprises a nonmagnetic layer comprising a nonmagnetic powder and a binder between the nonmagnetic support and the magnetic layer.

18. The method according to claim 17, wherein said magnetic recording medium further comprises an intermediate layer comprising a principal component in the form of a radiation-curing resin between the nonmagnetic support and the nonmagnetic layer or the nonmagnetic layer and the magnetic layer.

19. An apparatus comprising a recording head, a magnetic recording medium and a reproduction head, wherein
said recording head records a magnetic signal on said magnetic recording medium and said reproduction head reproduces the recorded signal,
said magnetic recording medium comprises a magnetic layer comprising a ferromagnetic powder, a binder and an abrasive on a nonmagnetic support,
said abrasive has a Vickers hardness ranging from 18 to 80 GPa and a mean particle diameter ranging from 10 to 100 nm,
said magnetic layer comprises said abrasive in a quantity of 5 to 60 weight parts per 100 weight parts of the ferromagnetic powder,
said magnetic layer has a thickness ranging from 10 to 100 nm, and
the number of abrasive present on the surface of said magnetic layer ranges from 0.01 to 1 per {(minimum bit length of the recorded signal)×(read track width of the reproduction head)} micrometer².

20. The apparatus according to claim 19, wherein said abrasive has a mean particle diameter of not greater than twice the minimum bit length of said recorded signal.

21. The apparatus according to claim 19, wherein said magnetic layer has a surface roughness Ra of equal to or less than 2.0 nm.

22. The apparatus according to claim 19, wherein said ferromagnetic powder is a hexagonal ferrite powder having a mean plate diameter ranging from 10 to 40 nm or a ferromagnetic metal powder having a mean major axis length ranging from 25 to 100 nm.

23. The apparatus according to claim 19, wherein the minimum bit length of said recorded signal is equal to or less than 100 nm.

24. The apparatus according to claim 19, wherein the read track width of said reproduction head is equal to or less than 2500 nm.

25. The apparatus according to claim 19, wherein said magnetic recording medium further comprises an intermediate layer comprising a principal component in the form of a radiation-curing resin between the nonmagnetic support and the magnetic layer.

26. The apparatus according to claim 19, wherein said magnetic recording medium further comprises a nonmagnetic layer comprising a nonmagnetic powder and a binder between the nonmagnetic support and the magnetic layer.

27. The apparatus according to claim 26, wherein said magnetic recording medium further comprises an intermediate layer comprising a principal component in the form of a radiation-curing resin between the nonmagnetic support and the nonmagnetic layer or the nonmagnetic layer and the magnetic layer.
